(19) United States
(12) Patent Application Publication
(10) Pub. No.: US 2022/0051074 A1
(43) Pub. Date: Feb. 17, 2022

(54) QUANTITATIVE SPECTRAL DATA ANALYSIS AND PROCESSING METHOD BASED ON DEEP LEARNING

(71) Applicant: ZHEJIANG UNIVERSITY, Zhejiang (CN)

(72) Inventors: Tao LIN, Zhejiang (CN); Xiaolei ZHANG, Zhejiang (CN); Yibin YING, Zhejiang (CN)

(73) Assignee: ZHEJIANG UNIVERSITY, Zhejiang (CN)

(21) Appl. No.: 17/274,436

(22) PCT Filed: Aug. 20, 2019
(86) PCT No.: PCT/CN2019/101573

§ 371 Date: Mar. 9, 2021

(30) Foreign Application Priority Data
Oct. 10, 2018 (CN) 201811179747.2

(51) Int. Cl. G06N 3/04

(52) U.S. Cl. CPC G06N 3/04

(57) ABSTRACT

A quantitative spectral data analysis and processing method based on deep learning is provided. Pre-processing is not required to be performed on data in the disclosure. Effective information and background information may be learned from raw spectral data, and accuracy of quantitative spectral analysis is improved. In the disclosure, high-dimensional features are extracted from spectral data through three convolutional layers. Convolution kernels of 1×1 are adopted in the second layer, which reduces the dimensionality and the amount of calculation. Further, convolution kernels of three different sizes are adopted in the third convolutional layer, which learns features of different sizes hidden in the spectral data from the raw spectral data. In this disclosure, data is not pre-processed, and the original data may be directly processed. This method has a high generalization ability when a spectral noise distribution of a test set is different from that of a training set.

### BACKGROUND

### Technical Field

The disclosure relates to a spectral analysis field, and in particular, relates to a quantitative spectral data analysis and processing method based on deep learning.

### Description of Related Art

The development of chemometrics has facilitated the applications of spectral analysis in the fields of agricultural products, pharmaceuticals, petroleum, and soil. Additionally, chemometrics has been widely used in the qualitative and quantitative analysis of infrared spectrum and Raman spectrum. The conventional data analysis process of chemometrics includes two steps, namely spectral pre-processing and calibration model building. Spectral pre-processing is mainly used to remove noise in spectral data and improve prediction accuracy of the model. On one hand, spectral pre-processing mainly includes four steps: baseline correction, multiplicative scattered correction, smoothing, and normalization. Each step includes different data processing methods. Choosing a combination of pre-processing methods through trial and error may increase complexity of the model-building process, and more time may be consumed. On the other hand, when the spectral data collection environment, collection instrument, or sample source changes, the noise distribution in the data may change as well. When the original pre-processing method being applied to the new data, the original pre-processing method cannot effectively remove noise and may further introduce new noise, and the prediction of the model may thus become worse.

Deep learning is a data-driven learning method. The deep learning model could automatically learn the low-dimensional and high-dimensional features from the original spectral data. In a conventional artificial neural network, when analyzing the spectral data, the principal component analysis and other methods are often used first for dimensionality reduction. Further, the artificial neural network is prone to overfitting due to the large number of parameters. In contrast, a convolutional neural network with local connection and weight sharing to extract local features from spectral data and reduce the risk of overfitting. Spectral pre-processing is still needed for the existing convolutional neural network models. A few studies utilize convolutional neural network as a feature extraction method. Acquarelli et al. has proposed a one-layer convolutional neural network qualitative analysis model. Nevertheless, such model still provides favorable effects on the spectral data with pre-processing (J. Acquarelli., T. v., Laarhoven, J., Gerretzen, T. N., Tran, L. M. C., Buydens, E., Marchiori, Convolutional Neural Networks for Vibrational Spectroscopic Data Analysis, 2017). Malek et al. has proposed a quantitative analysis model of convolutional neural networks. Nevertheless, in this model, the convolutional neural network is used for feature extraction, and the extracted features are trained in the regression model (S., Malek, F., Melgani, Y., Bazi, One-dimensional convolutional neural networks for spectroscopic signal regression, 2017).

### SUMMARY

In order to overcome shortcomings of the existing chemometric modeling method, the disclosure provides a quantitative spectral data analysis and processing method based on deep learning. The method provided by the disclosure is a data-driven model building method without data pre-processing through which features of different sizes may be extracted through convolution kernels of different sizes without removing background noise from original spectral data, a predictive result is outputted, and accuracy of prediction is improved.

As shown in FIG. 1, technical solutions provided by the disclosure include the following.

Step 1): Build a one-dimensional convolutional neural network model, optimize, calculate, and obtain hyperparameters of the model.

Step 2): Feed spectral data with known target value of a sample to the convolutional neural network model, train weights of the model by adopting an Adam optimization algorithm in combination with a backpropagation algorithm, obtain an optimal model after a plurality of rounds of training, and obtain a trained mode.

Step 3): Feed spectral data with unknown target value to the trained model, and obtain results of predicted values of the spectral data.

Data pre-processing is required on all of the existing spectral data. After removing uninformative information, and effective information is used to build a partial least squares (PLS) method, an artificial neural network (ANN) method and other methods to build a regression model.

A convolutional neural network model provided by the disclosure with a specific structure directly processes raw spectral data without background information removal, and obtains high detection accuracy.

The samples of the disclosure include soil, animal feed, grains and so on. One spectrum corresponds to a soil sample, an animal feed sample, or a grain sample.

Step 1) further comprises the following steps.

1.1) As shown in FIG. 2, the convolutional neural network model is formed mainly by connecting an input layer, a convolutional layer 1, a convolutional layer 2, a convolutional layer 3, a flatten layer, a fully-connected layer, and an output layer. A full band raw spectrum is fed into the input layer.

The first convolutional layer includes one convolutional module using 8 convolutional kernels, and sizes of all convolutional kernels are identical.

The second convolutional layer comprises three parallel modules of two convolutional modules and one pooling module. Output of the first convolutional layer is fed to the two convolution modules and the one pooling module of the second convolutional layer. Each of the convolution modules of the second convolutional layer uses one type of convolution kernels, the convolution kernels of the two convolution modules of the second convolutional layer are different, and each of the convolution modules of the second convolutional layer has 4 convolution kernels of 1×1×8. The pooling module of the second convolutional layer includes 4 parallel maximum pooling structures.

The third convolutional layer comprises four convolution modules, and the four convolution modules of the third convolutional layer use four different types of convolution kernels respectively. A first convolution module of the third convolutional layer includes four first-type convolution kernels of 1×1×8, a second convolution module of the third convolutional layer includes four second-type convolution kernels of p×1×4, a third convolution module of the third convolutional layer includes four third-type convolution kernels of q×1×4, and a fourth convolution module of the third convolutional layer includes four fourth-type convolution kernels of 1×1×4, where p and q respectively represents sizes of the second-type convolution kernel and the third-type convolution kernel. Output of the first-type convolution kernel is fed into the first convolution module of the third convolutional layer. The two convolution modules and the one pooling module of the second convolutional layer are fed into the last three convolution modules of the third convolutional layer. The flatten layer converts output of the third convolutional layer into a one-dimensional vector.

An objective function loss of the convolutional neural network model is formed by a mean square error and a second norm regularization function:

$$loss = \frac{1}{N} {\sum }_{n = 1}^{N} [ {( {γ}_{n} - {\hat{γ}}_{n} )}^{2} ] + λ {‖ w ‖}^{2}$$

where λ is a regularization coefficient of the objective function, and w is the weight of the model.

1.2) Optimize sizes and stride lengths of the convolution kernels of the convolutional layers, including the sizes and the stride lengths of the convolution kernels of the first convolutional layer and the sizes and the stride lengths of two convolution kernels of the third convolutional layer, by a random grid search method. The sizes and the stride lengths of the convolution kernels of the second convolutional layer are fixed values. Optimize hyperparameters in the convolutional layers in a following hyperparameter search space by specifically adopting the random grid search method. Select and obtain a group of optimal hyperparameters by adopting a five-fold cross-validation.

Ranges of the sizes and the stride lengths of the different convolution kernels of the three convolutional layers are provided as follows. A range of sizes of the convolution kernels of the first convolutional layer is 2-19 and a range of stride lengths of the convolution kernels of the first convolutional layer is 2-9. A size of the first convolution kernel of the second convolutional layer is set to be 1 and a stride length of the first convolutional kernel of the second convolutional layer is set to be 1. A size of the second convolution kernel of the second convolutional layer is set to be 1 and a stride length of the second convolutional kernel of the first convolutional layer is set to be 1. A size of the first convolution kernel of the third convolutional layer is set to be 1, and a range of size p of the second convolution kernel of the third convolutional layer is 2-5. A range of size q of the third-type convolution kernel of the second convolutional layer is 6-9, and a range of a stride length of four convolution kernels in the third convolutional layer is 2-9.

Activation functions of the three convolutional layers and the fully-connected layer in the model are Leaky ReLU functions, and the output layer of the model does not include the activation function.

The number of the neuron in the last output layer is 1.

In step 2), spectral data with known target values are fed into the convolutional neural network model, an Adam algorithm in combination with a backpropagation algorithm are used to train the weight of the obtained model, and 5,000 epochs of training are performed.

In step 3), a predictive value of each spectrum is outputted and predicted through the model.

The predicted value may be, for example, an organic carbon content of soil, a protein content of animal feed, a protein content of grain samples, and the like.

In implementation, the data is divided into a training set and a test set. The training set is used for model training, and a trained model is saved. Raw spectral data of the test set is fed into the trained model for prediction. For model evaluation, a coefficient of determination (R²) and a root mean square error of prediction (RMSEP) of the test set are outputted.

Effects provided by the disclosure includes the following.

In the disclosure, pre-processing is not required to be performed on spectral data. The effective spectral information and background information hidden in the data may be learned, and accuracy of quantitative spectral analysis is improved. In the disclosure, high-dimensional features may be extracted from the spectral data through the three convolutional layers. Further, convolution kernels of three different sizes are adopted in the third convolutional layer, and in this way, features of different sizes hidden in the spectral data may be learned from the raw spectral data. Data is not pre-processed in the disclosure, and the original data may be directly processed. When a spectral noise distribution of the test set is different from that of the training set, a high generalization ability is provided by the disclosure.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a flow chart of building a model according to an embodiment of the disclosure.

FIG. 2 is a quantitative analysis structural diagram of the model.

### DESCRIPTION OF THE EMBODIMENTS

To better understand the disclosure, the following embodiments are included to provide detailed description of the disclosure. Nevertheless, the protection scope of the disclosure is not limited to the scope shown in the embodiments. The following embodiments are run on Python software. The disclosure is further described in detail in combination with accompanying figures and embodiments.

The specific embodiments which are implemented according to an overall method provided by the disclosure are provided as follows.

This embodiment is applied to a quantitative analysis of a near-infrared spectrum to predict an organic carbon content of soil. A selected data set is a public data set of the soil. Soil samples come from the United States, Africa, Asia, South America, and Europe. One sample is collected in a single soil. A total of 3,793 pieces of soil spectral data are provided and are divided into 2,502 training set samples and 1,291 test set samples. A FieldSpec Pro-FR spectrometer is used to collect the spectral data, and a band range of the spectral data is 350 nm to 2,500 nm. Regarding all of the soil samples, a minimum organic carbon content is 0, a maximum organic carbon content is 241.6 g kg⁻¹, an average organic carbon content is 11.97 g kg⁻¹, and a standard deviation of organic carbon content is 20.87 g kg⁻¹.

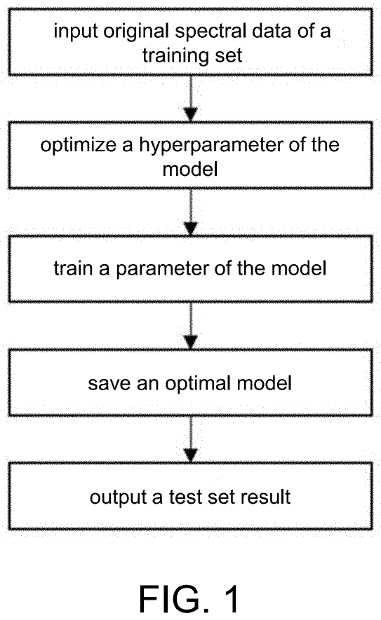

As shown in the steps of FIG. 1, specific implementation of the embodiments is provided as follows.

1) Training set data is fed into a model.

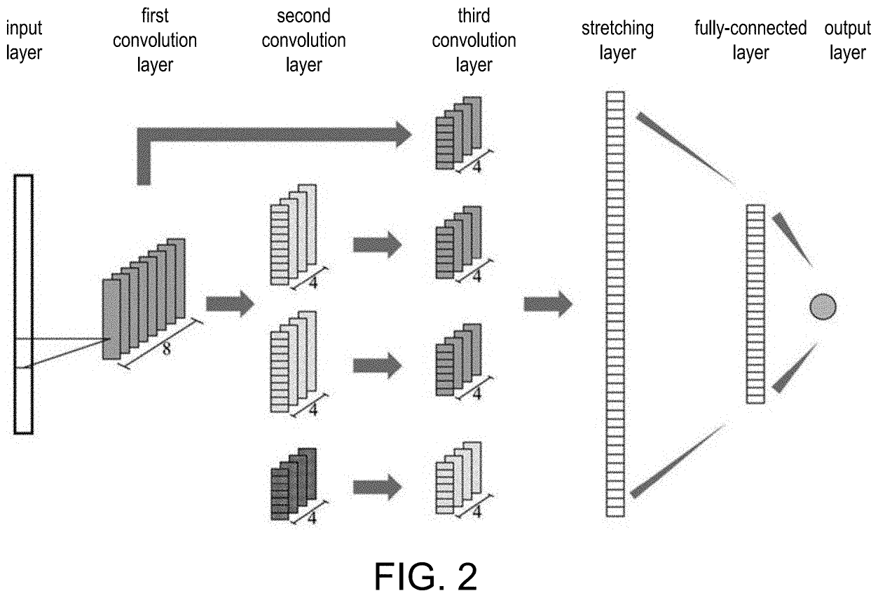

2) Optimize hyperparameters of the model. A structure of the model is shown in FIG. 2. Specifically, the structure of the model includes three convolutional layers, named as a first convolutional layer, a second convolutional layer, and a third convolutional layer, a flatten layer, a fully-connected layer, and an output layer. The first convolutional layer uses 8 convolution kernels, an optimal size of the convolution kernels is 9, and a stride length is 5. The third convolutional layer includes four convolution modules and uses 16 convolution kernels, which are convolution kernels of four different sizes, and one 1×1×8 convolution kernel is included. Sizes of second-type convolution kernels and third-type convolution kernels respectively are 5 and 7, and stride lengths of the four types of convolution kernels are all 3. A number of neurons of the fully-connected layer is 64. A number of neurons of the output layer is 1 (FIG. 2).

3) After the hyperparameter of the model is fixed, all of the training set data is used again to train parameters of the model. A weight of the model is trained on a training set through a backpropagation algorithm. The model is trained for 5,000 rounds.

4) After the model is trained, end the training. An optimal model is saved, and an effect of the model is tested on the test set. A predicted value of each spectrum to be tested and a coefficient of determination (R²) and a root mean square error of prediction (RMSEP) of the model on the test set are outputted.

5) Conventional partial least squares-linear discriminant analysis (PLS-LDA) and principal component analysis-artificial neural network (PCA-ANN) methods are used to respectively predict original soil spectra with and without pre-processing. An optimal result which is obtained is prediction of the original spectrum without pre-processing through PCA-ANN, where RMSEP is 11.59, and R² is 0.72. The original spectrum without pre-processing is predicted through the method provided by the disclosure, and the predicted RMSEP is 8.88, and R² is 0.84. Through comparison, it can be seen that the accuracy of prediction of the original spectrum without data pre-processing through the method provided by the disclosure is greater than that with pre-processing and without pre-processing through the conventional model building method. As such, accuracy of prediction of the near-infrared spectrum performed on the soil samples may thus be improved. The test set samples and the training set samples come from different regions. The accuracy of prediction of the test set is high, and it thus can be seen that a favorable generalization ability is provided by the disclosure.

### COMPARATIVE EXAMPLE

The data with pre-processing of the model is compared, and the comparison process is provided as follows.

1) Training set data are fed into a model.

2) Optimize a hyperparameter of the mode. A structure of the model is shown in FIG. 2. Specifically, the structure of the model includes three convolutional layers, named as a first convolutional layer, a second convolutional layer, and a third convolutional layer, a flatten layer, a fully-connected layer, and an output layer. The first convolutional layer uses 8 convolution kernels, an optimal size of the convolution kernels is 9, and a stride length is 5. The third convolutional layer includes four convolution modules and uses 16 convolution kernels, which are convolution kernels of four different sizes, and one 1×1×8 convolution kernel is included. Sizes of second-type convolution kernels and third-type convolution kernels respectively are 5 and 7, and stride lengths of the four types of convolution kernels are 3. A number of neurons of the fully-connected layer is 64. A number of neurons of the output layer is 1 (FIG. 2).

3) After the hyperparameter of the model is fixed, all of the training set data is used again to train parameters of the model. A weight of the model is trained on a training set through a backpropagation algorithm. The model is trained for 5,000 rounds.

4) After the model is trained, end the training. An optimal model is saved, and an effect of the model is tested on the test set. A predicted value of each spectrum to be tested and a coefficient of determination (R²) and a root mean square error of prediction (RMSEP) of the model on the test set are outputted.

5) The original spectrum with pre-processing is predicted through the method provided by the disclosure, and the predicted RMSEP is 12.92, and R² is 0.65. Through comparison, it can be seen that accuracy of prediction of the spectrum with data pre-processing is worse than the accuracy of prediction of the original spectrum.

1. A quantitative spectral data analysis and processing method based on deep learning, comprising:
step 1): building a one-dimensional convolutional neural network model, optimizing and calculating a hyperparameter of the model;
step 2): feeding spectral data with known predicted value of a sample to the model, training a weight of the model, obtaining an optimal model after a plurality of rounds of training, obtaining a trained model; and
step 3): feeding spectral data of with unknown target value to the trained model, outputting and obtaining a predicted value of the spectral data.

2. The quantitative spectral data analysis and processing method based on deep learning according to claim 1, wherein step 1) further comprises:
1.1) building the one-dimensional convolutional neural network model by connecting an input layer, a first convolutional layer, a second convolutional layer, a third convolutional layer, a flatten layer, a fully-connected layer, and an output layer together in sequence, wherein an original full band spectrum is fed to the input layer,
wherein the first convolutional layer comprises one convolution module using 8 convolution kernels, sizes of all convolution kernels are identical,
wherein the second convolutional layer comprises three parallel modules of two convolution modules and one pooling module, output of the first convolutional layer is fed into the two convolution modules of the second convolutional layer and the one pooling module of the second convolutional layer, each of the convolution modules of the second convolutional layer uses one type of convolution kernels, the convolution kernels of the two convolution modules of the second convolutional layer are different, each of the convolution modules of the second convolutional layer has 4 convolution kernels of 1×1×8, and the pooling module of the second convolutional layer comprises 4 parallel maximum pooling structures,
wherein the third convolutional layer comprises four convolution modules, the four convolution modules of the third convolutional layer use four different types of convolution kernels respectively, a first convolution module of the third convolutional layer comprises four first-type convolution kernels of 1×1×8, a second convolution module of the third convolutional layer comprises four second-type convolution kernels of p×1×4, a third convolution module of the third convolutional layer comprises four third-type convolution kernels of q×1×4, a fourth convolution module of the third convolutional layer comprises four fourth-type convolution kernels of 1×1×4, and p and q respectively represents sizes of the second-type convolution kernel and the third-type convolution kernel, wherein output of the first convolutional layer is fed into the first convolution module of the third convolutional layer, the two convolution modules and the one pooling module of the second convolutional layer are fed into the last three convolution modules of the third convolutional layer, and the flatten layer converts output of the third convolutional layer into a one-dimensional feature vector,
wherein an objective function loss of the convolutional neural network model is formed by a mean square error and a second norm regularization function:
$$loss = \frac{1}{N} {\sum }_{n = 1}^{N} [ {( {γ}_{n} - {\hat{γ}}_{n} )}^{2} ] + λ {‖ w ‖}^{2}$$
where λ is a regularization coefficient of the objective function, and w is the weight of the model; and
1.2) optimizing sizes and stride lengths of the convolution kernels of the convolutional layers, comprising the sizes and the stride lengths of the convolution kernels of the first convolutional layer and the sizes and the stride lengths of two convolution kernels of the third convolutional layer, by a random grid search method, wherein the sizes and the stride lengths of the convolution kernels of the second convolutional layer are fixed values, searching hyperparameters in the convolutional layers in a following hyperparameter search space by the random grid search method, selecting and obtaining a group of an optimal hyperparameter combination formed hyperparameters by a five-fold cross-validation,
wherein ranges of the sizes and the stride lengths of the different convolution kernels of the three convolutional layers are provided as follows: a range of sizes of the convolution kernels of the first convolutional layer is 2-19 and a range of stride lengths of the convolution kernels of the first convolutional layer is 2-9; a size of the first convolution kernel of the second convolutional layer is set to be 1 and a stride length of the first convolutional kernel of the second convolutional layer is set to be 1, a size of the second convolution kernel of the second convolutional layer is set to be 1 and a stride length of the second convolutional kernel of the second convolutional layer is set to be 1; and a size of the first convolution kernel of the third convolutional layer is set to be, a range of a size p of the second convolution kernel of the third convolutional layer is 2-5, a range of a length q of a third-type convolution kernel of the second convolutional layer is 6-9, a range of a stride length of four convolution kernels in the third convolutional layer is 2-9.

3. The quantitative spectral data analysis and processing method based on deep learning according to claim 2, wherein activation functions of the three convolutional layers and the fully-connected layer in the model are Leaky ReLU functions, and the output layer of the model does not comprise the activation function.

4. The quantitative spectral data analysis and processing method based on deep learning according to claim 1, wherein in step 2), spectral data with known target value is fed into the convolutional neural network model, an Adam algorithm in combination with a backpropagation algorithm are used to train the weight of the model, and 5,000 epochs of training are performed.

5. The quantitative spectral data analysis and processing method based on deep learning according to claim 1, wherein in step 3), a predictive value of each spectrum is outputted and predicted through the model.
